(19) United States
(12) Patent Application Publication
(10) Pub. No.: US 2026/0326471 A1
(43) Pub. Date: Oct. 22, 2026

(54) BOOKBINDING STRUCTURE

(71) Applicants: Hiroshi HASEGAWA, Toyooka-Shi, Hyogo (JP); GUMU CORP PTY LTD, NEWBOROUGH, VICTORIA (AU)

(72) Inventor: Hiroshi HASEGAWA, Toyooka-Shi, Hyogo (JP)

(21) Appl. No.: 19/114,686

(22) PCT Filed: Sep. 26, 2022
(86) PCT No.: PCT/JP2022/035577

§ 371 Date: Mar. 24, 2025

(51) Int. Cl. B42D 1/06; B42D 1/00; B42D 3/00

(52) U.S. Cl. CPC B42D 1/06; B42D 1/006; B42D 3/00

(57) ABSTRACT

A bookbinding structure includes a sheet in which page surfaces P(n), P(n+1) adjacent to each other are formed on an inner side of a valley fold. The sheet includes: an insertion piece that is continuous with one page surface of the page surfaces P(n), P(n+1) via a mountain fold line parallel to the valley fold line and is able to be mountain-folded; and receiving-portion forming pieces each of which is continuous via a mountain fold line on a respective one of two edges, which are orthogonal to the valley fold line, of the other page surface P(n+1) of the page surfaces P(n), P(n+1), the mountain fold line being one of mountain fold lines orthogonal to the valley fold line, the receiving-portion forming pieces forming an insertion receiving portion into which an insertion piece that is mountain-folded in another sheet disposed to be adjacent to the sheet is insertable.

### TECHNICAL FIELD

The present invention relates to a bookbinding structure.

### Background Art

As a conventional bookbinding structure, a structure has been known that binds printed matters and the like by thread, a stapler, glue, and the like (for example, Patent Literature 1).

Hitherto, as shown in Patent Literature 2, for example, a bookbinding structure has also been known in which each of the back sides of mountain fold lines of a B4 or A4 sized book obtained by folding a long-length paper in half is adhered to an inner surface of the back side of a cover.

However, in the conventional bookbinding structures described above, it has not been possible to easily perform bookbinding because it has been troublesome and time-consuming without the knowledge and skills for bookbinding.

### CITATION LIST

### Patent Literature

Patent Literature 1: Japanese Utility Model Registration No. 3080553

Patent Literature 2: Japanese Utility Model Registration No. 3029417

### SUMMARY OF INVENTION

### Technical Problem

A problem to be solved by the present invention is to provide a bookbinding structure by which bookbinding can be easily performed.

### Solution to Problem

In order to solve the problem described above, a bookbinding structure of the present invention includes a plurality of sheets in which page surfaces adjacent to each other are formed on an inner side of a valley fold by having each sheet valley-folded along a valley fold line. In the bookbinding structure, the sheet includes: an insertion piece that is continuous with one page surface of the page surfaces adjacent to each other in the sheet via a mountain fold line parallel to the valley fold line, the insertion piece being able to be mountain-folded; and receiving-portion forming pieces each of which is continuous via a mountain fold line on a respective one of two edges, which are orthogonal to the valley fold line, of the other page surface of the page surfaces adjacent to each other in the sheet, the mountain fold line being one of mountain fold lines orthogonal to the valley fold line, the receiving-portion forming pieces forming an insertion receiving portion into which an insertion piece that is mountain-folded in another sheet disposed to be adjacent to the sheet is inserted by having the receiving-portion forming piece mountain-folded to a back surface side of the other page surface.

The bookbinding structure has the configuration described above, and hence effects as follows can be obtained.

A plurality of sheets having the configuration described above are prepared. Each sheet is valley-folded along the valley fold line, to thereby form the page surfaces adjacent to each other on the inner side of the valley fold. In addition, the insertion piece continuous with one page surface of the page surfaces adjacent to each other in the sheet is mountain-folded at the mountain fold line parallel to the valley fold line. The receiving-portion forming pieces respectively continuous via the mountain fold lines, which are orthogonal to the valley fold line, on two edges, which are orthogonal to the valley fold line, of the other page surface of the page surfaces adjacent to each other in the sheet are mountain-folded to the back surface side of the other page surface. As a result, the insertion receiving portion is formed.

Then, the sheets adjacent to each other are joined to each other by inserting the insertion piece of each of the plurality of prepared sheets into the insertion receiving portion in the adjacent sheet.

As a result, page surfaces that are consecutive in a book-like manner can be formed. In other words, bookbinding can be performed.

As above, according to the bookbinding structure of the present invention, bookbinding can be easily performed by simply valley-folding or mountain-folding each parts described above and inserting each insertion piece into the insertion receiving portion in the adjacent sheet.

In addition, a structure in which the insertion piece is inserted into the insertion receiving portion in the adjacent sheet is provided, and hence the pages can be easily swapped, increased, or reduced.

In the bookbinding structure, at least one pair of covers can be further included. In one of the covers, a receiving-portion forming piece that forms an insertion receiving portion into which an insertion piece of the sheet adjacent to the one of the covers of the plurality of sheets is to be inserted is provided, and in the other of the covers, an insertion piece to be inserted into the insertion receiving portion of the sheet adjacent to the other of the covers of the plurality of sheets is provided.

By the configuration as above, the covers can be easily provided by inserting the insertion piece of the sheet adjacent to the cover of the plurality of sheets into the insertion receiving portion provided in one cover, and inserting the insertion piece provided in the other cover (for example, a back cover) into the insertion receiving portion of the sheet adjacent to the other cover of the plurality of sheets.

### BRIEF DESCRIPTION OF DRAWINGS

FIG. 1 is a view showing an embodiment of a bookbinding structure according to the present invention in which FIG. 1(a) is an exploded perspective view of a main part and FIG. 1(b) is a perspective view showing a structure example of a cover.

FIG. 2 is a perspective view showing an inner structure of the same embodiment.

FIG. 3(a) is an enlarged view of part a in FIG. 3(b), and FIG. 3(b) is a perspective view showing an open state.

FIG. 4(a) is a plan view showing a creation example of a sheet, and FIG. 4(b) is a developed plan view showing one example of the sheet.

FIG. 5 is a perspective view of the sheet.

FIG. 6(a) is a perspective view of one example of the cover, and FIG. 6(b) is a plane of a developed view of one example of a cover sheet.

FIG. 7(a) is a perspective view of another example of the cover, and FIG. 7(b) is a plane of a developed view of another example of the cover sheet.

### DESCRIPTION OF EMBODIMENT

An embodiment of a bookbinding structure according to the present invention is described below with reference to the drawings. In each drawing, the same parts and equivalent parts are denoted by the same reference characters.

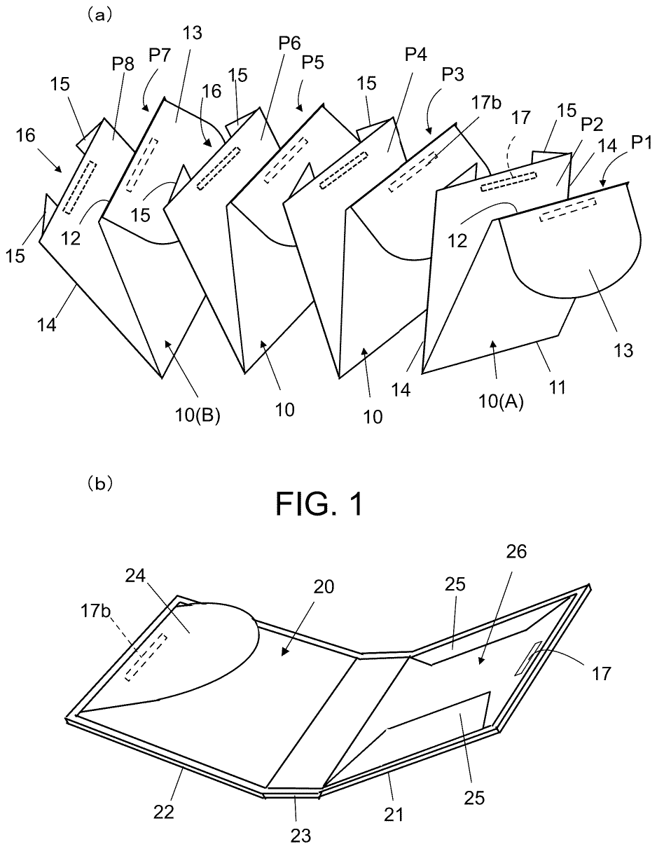

The bookbinding structure of the embodiment shown in FIGS. 1 to 3 (mainly FIG. 1(a)) is a bookbinding structure having a plurality of sheets 10. Each of the plurality of sheets 10 is valley-folded along a valley fold line 11. As a result, page surfaces P (for example, P1 and P2, P3 and P4, and the like in FIG. 1) adjacent to each other are formed on the inner side of a valley fold. Four sheets 10 are representatively illustrated in FIG. 1(a), but any number of sheets may be employed as the number of the sheets 10.

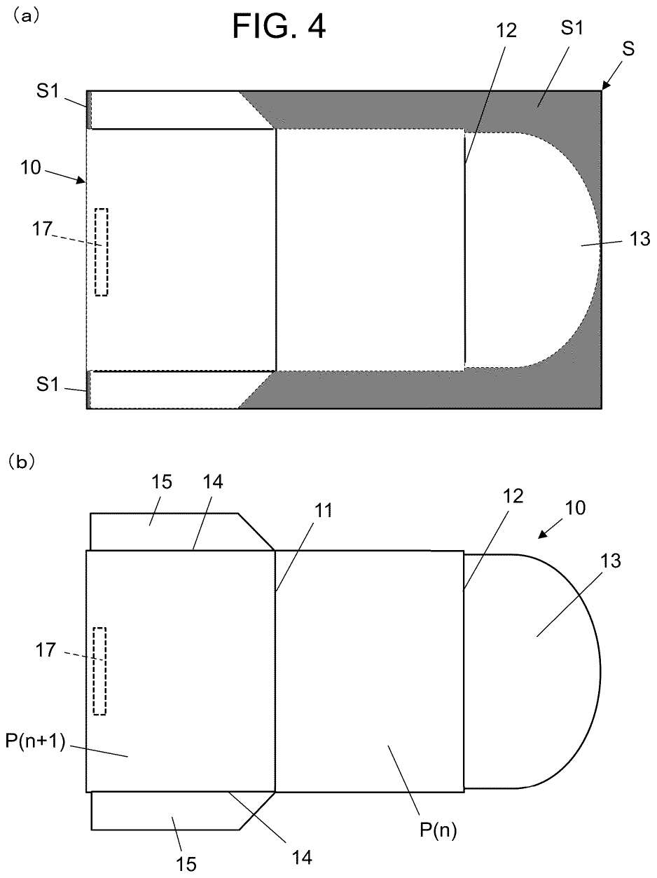

As shown in FIG. 4(b), the sheet 10 includes an insertion piece 13 and receiving-portion forming pieces 15, 15. The insertion piece 13 is continuous with one page surface P(n) of page surfaces P(n), P(n+1) adjacent to each other in the sheet 10 via a mountain fold line 12 parallel to the valley fold line 11 and can be mountain-folded. The receiving-portion forming pieces 15, 15 are respectively continuous via mountain fold lines 14, 14, which are orthogonal to the valley fold line 11, on two edges, which are orthogonal to the valley fold line 11, of the other page surface P(n+1) of the page surfaces P(n), P(n+1) adjacent to each other in the sheet 10, and are mountain-folded to the back surface side of the other page surface P(n+1). As a result, as shown in FIG. 1(a), an insertion receiving portion 16 into which an insertion piece 13 mountain-folded in another sheet 10 disposed to be adjacent to the sheet 10 is inserted is formed. Note that n is an integer equal to or more than 1.

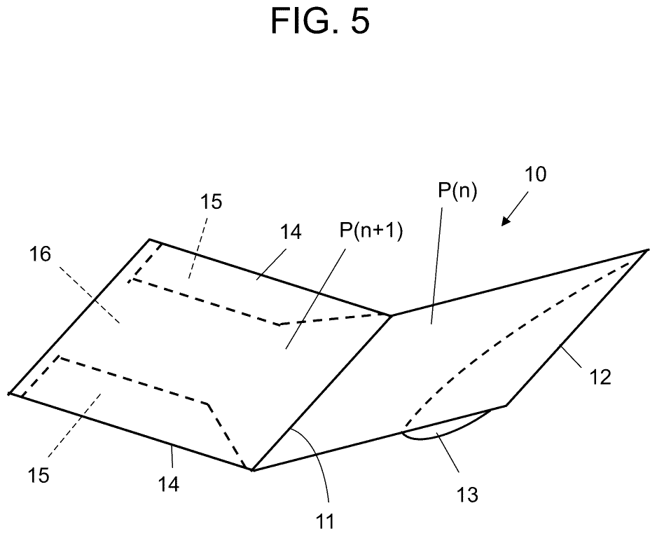

The bookbinding structure has the configuration described above, and hence effects as follows can be obtained. For example, a plurality of sheets 10 as those shown in FIG. 4(b) are prepared. As shown in FIG. 5, each sheet 10 is valley-folded along the valley fold line 11, to thereby form the page surfaces P(n), P(n+1) adjacent to each other on the inner side of the valley fold. In addition, the insertion piece 13 continuous with one page surface P(n) of the page surfaces P(n), P(n+1) adjacent to each other in the sheet 10 is mountain-folded at the mountain fold line 12 parallel to the valley fold line 11. The receiving-portion forming pieces 15, 15 respectively continuous via the mountain fold lines 14, 14, which are orthogonal to the valley fold line 11, on two edges, which are orthogonal to the valley fold line 11, of the other page surface P(n+1) of the page surfaces P(n), P(n+1) adjacent to each other in the sheet 10 are mountain-folded to the back surface side of the other page surface P(n+1). As a result, the insertion receiving portion 16 is formed.

Then, the sheets 10 adjacent to each other are joined to each other by inserting the insertion piece 13 of each of the plurality of prepared sheets 10 into the insertion receiving portion 16 in the adjacent sheet 10 as shown in FIG. 1(a), for example.

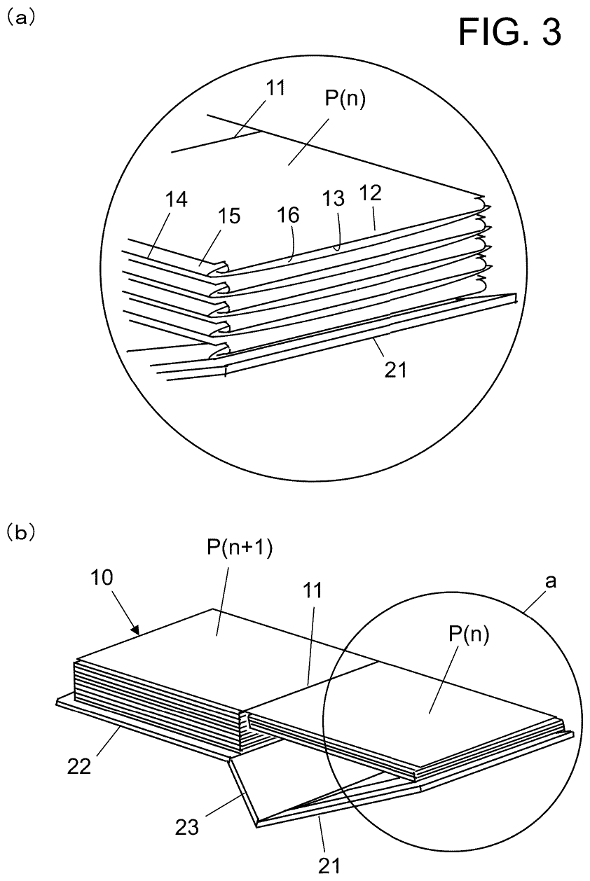

As a result, page surfaces that are consecutive in a book-like manner can be formed (see FIG. 3). In other words, bookbinding can be performed.

As above, according to the bookbinding structure of this embodiment, bookbinding can be easily performed by simply valley-folding or mountain-folding each parts described above and inserting each insertion piece 13 into the insertion receiving portion 16 in the adjacent sheet 10.

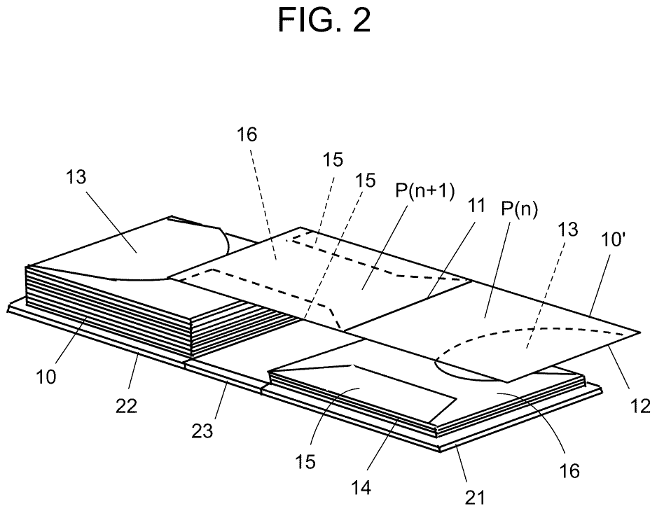

In addition, a structure in which the insertion piece 13 is inserted into the insertion receiving portion 16 in the adjacent sheet 10 is provided, and hence the pages can be easily swapped, increased, or reduced (see FIG. 2). In FIG. 2, reference character 10′ indicates a sheet to be swapped, increased, or reduced.

As shown in FIG. 1 to FIG. 3, the bookbinding structure of this embodiment includes at least one pair of covers 21, 22. Reference character 23 indicates a back but the back 23 does not necessarily need to be provided.

In one cover 21, receiving-portion forming pieces 25 that form an insertion receiving portion 26 into which the insertion piece 13 of the sheet 10 (for example, reference character 10(A) in FIG. 1(a)) adjacent to the cover 21 of the plurality of sheets 10 described above is to be inserted is provided. In the other cover (back cover) 22, an insertion piece 24 to be inserted into the insertion receiving portion 16 of the sheet 10 (for example, reference character 10(B) in FIG. 1(a)) adjacent to the other cover 22 of the plurality of sheets 10 described above is provided.

By the configuration as above, the covers 21, 22 can be easily provided by inserting the insertion piece 13 of the sheet 10 (reference character 10(A) in the example in FIG. 1) adjacent to one cover 21 of the plurality of sheets 10 into the insertion receiving portion 26 provided in the cover, and inserting the insertion piece 24 provided in the other cover (back cover) 21 into the insertion receiving portion 16 of the sheet 10 (reference character 10(B) in the example in FIG. 1) adjacent to the other cover 22 of the plurality of sheets 10.

The insertion receiving portion 26 in the cover 21 and the insertion piece 24 in the other cover 22 can be configured with use of a cover sheet 20 having the substantially same configuration as the sheet 10.

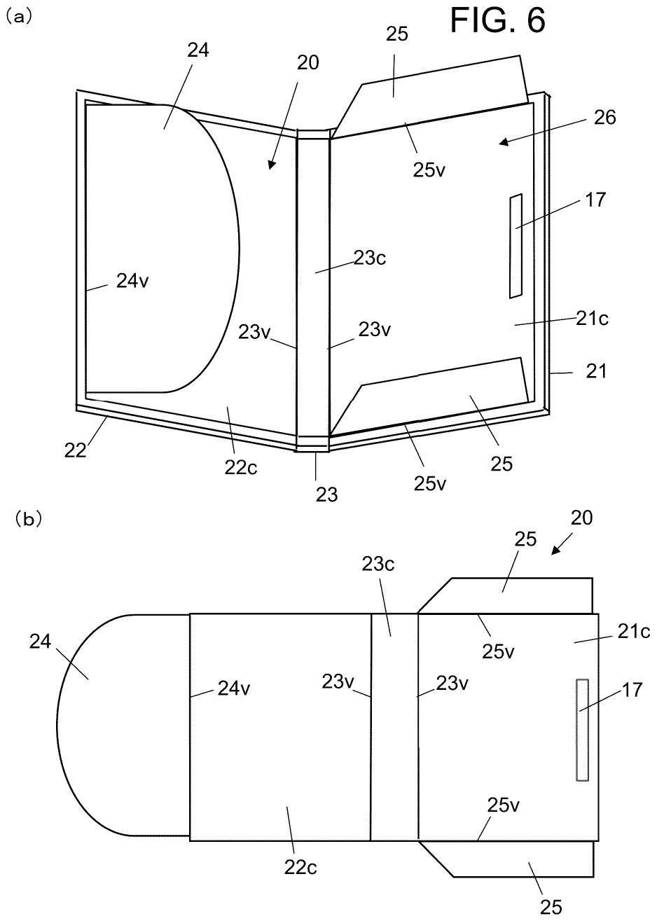

For example, as shown in FIG. 6, the cover having the configuration described above can be configured by using the cover sheet 20 having a cover corresponding portion 21c to be pasted to the cover 21, a back corresponding portion 23c that is continuous with the cover corresponding portion 21c via a valley fold line 23v and corresponds to the back 23, a back-cover corresponding portion 22c that is continuous with the back corresponding portion 23c via the valley fold line 23v and is to be pasted to the back cover 22, the insertion piece 24 continuous with the back-cover corresponding portion 22c via a valley fold line 24v, and the receiving-portion forming pieces 25, 25 continuous with the cover corresponding portion 21c via valley fold lines 25v, 25v, valley-folding each of the parts described above, pasting the cover corresponding portion 21c to the cover 21, and pasting the back-cover corresponding portion 22c to the back cover 22. The back corresponding portion 23c may be pasted or may not be pasted to the back 23.

Regarding the cover sheet 20 having the configuration as above, the cover can be configured by the cover sheet 20 itself.

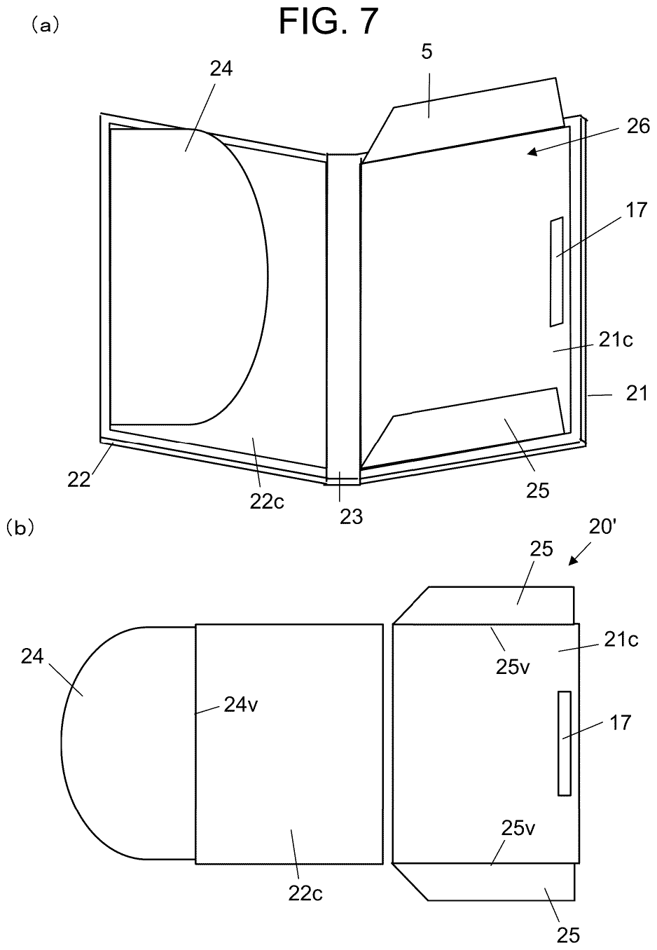

As shown in FIG. 7(b), for example, the insertion receiving portion 26 in the cover 21 and the insertion piece 24 in the other cover 22 can also be configured by a cover sheet 20′ separated into the cover corresponding portion 21c and the back-cover corresponding portion 22c without providing the back corresponding portion 23c.

The cover corresponding portion 21c is pasted to the cover 21, and the back-cover corresponding portion 22c is pasted to the back cover 22.

Each of the members forming the bookbinding structure as above can all be configured by an appropriate well-known material, for example, paper or a synthetic resin sheet.

The sheet 10 can be manufactured by cutting off an unnecessary portion S1 of a rectangular sheet S shown in FIG. 4(a), for example.

In FIG. 1 and the like, reference characters 17 and 17b indicate adhesion portions used as needed. The adhesion portions 17 and 17b are caused to adhere to each other by an adhesive (glue) or a double-sided tape.

Those adhesion portions 17, 17b are used when the pages are fixed. Normally, the adhesion portions 17, 17b are not used, and the sheets 10 are freely separable from each other.

The similar adhesion portion 17 is also provided in the cover 21.

The embodiment of the present invention has been described above, but the present invention is not limited to the embodiment described above and can be carried out in a modified form, as appropriate, within the gist of the present invention.

### REFERENCE SIGNS LIST

10: sheet
11: valley fold line
12: mountain fold line
13: insertion piece
14: mountain fold line
15: receiving-portion forming piece
16: insertion receiving portion
20: cover sheet
21: one cover
22: other cover (back cover)
24: insertion piece
25: receiving-portion forming piece
26: insertion receiving portion

1. A bookbinding structure, comprising a sheet in which page surfaces (P(n), P(n+1)) adjacent to each other are formed on an inner side of a valley fold by having the sheet valley-folded along a valley fold line, wherein the sheet includes:
an insertion piece that is continuous with one page surface (P(n)) of the page surfaces (P(n), P(n+1)) adjacent to each other in the sheet via a mountain fold line parallel to the valley fold line, the insertion piece being able to be mountain-folded; and
receiving-portion forming pieces each of which is continuous via a mountain fold line on a respective one of two edges, which are orthogonal to the valley fold line, of an other page surface (P(n+1)) of the page surfaces (P(n), P(n+1)) adjacent to each other in the sheet, the mountain fold line being one of mountain fold lines orthogonal to the valley fold line, the receiving-portion forming pieces forming an insertion receiving portion into which an insertion piece that is mountain-folded in another sheet disposed to be adjacent to the sheet is insertable by having the receiving-portion forming piece mountain-folded to a back surface side of the other page surface (P(n+1)).

2. The bookbinding structure according to claim 1, further comprising at least one pair of covers, wherein:
in one of the covers, a receiving-portion forming piece that forms an insertion receiving portion into which an insertion piece of the sheet adjacent to the one of the covers is to be inserted is provided; and
in an other of the covers, an insertion piece to be inserted into the insertion receiving portion of the sheet adjacent to the other of the covers is provided.
